(19) United States
(12) Patent Application Publication
(10) Pub. No.: US 2014/0238676 A1
(43) Pub. Date: Aug. 28, 2014

(54) CEMENT SLURRY COMPOSITIONS AND METHODS

(71) Applicant: SCHLUMBERGER TECHNOLOGY CORPORATION, Sugar Land, TX (US)

(72) Inventors: Clara Carelli, Cambridge (GB); Jesse C. Lee, Sugar Land, TX (US); Syed A. Ali, Sugar Land, TX (US)

(73) Assignee: SCHLUMBERGER TECHNOLOGY CORPORATION, Sugar Land, TX (US)

(21) Appl. No.: 13/776,877

(22) Filed: Feb. 26, 2013

(51) Int. Cl. C04B 22/06; E21B 33/13

(52) U.S. Cl. CPC C04B 22/06; E21B 33/13
USPC 166/292; 524/8

(57) ABSTRACT

A cement slurry composition is described as having cement, water, and organic polymeric particles. The composition also includes non-ionic surfactants, which may contain ethoxylate groups or contain both ethoxylate groups and propyxlate groups in the hydrophilic part. The non-ionic surfactant acts to disperse the hydrophobic polymeric particles in the slurry and to reduce or prevent foaming. The cement slurry composition is prepared and then pumped into the subterranean well and placed in a zone of the subterranean well. Time is then allowed for the cement slurry composition to set into a solid mass in the zone.

### BACKGROUND

The statements in this section merely provide background information related to the present disclosure and may not constitute prior art.

The present disclosure relates generally to compositions and methods for treating or completing a subterranean well having a borehole. More particularly, the disclosure relates to cement slurry compositions for cementing a subterranean well and, in the alternative, methods for subterranean well completions and\or cementing a subterranean well having a borehole. The present disclosure also relates to a method of preparing a cement slurry composition having polymer particles as additives and/or reducing foam in such cement slurry composition.

In a typical well cementing operation, a cement slurry is prepared at the surface and then pumped into the subterranean well through a liner or casing to fill the annulus between the casing and borehole wall. Once the slurry sets, the cement may provide a number of functions, including providing zonal isolation and segregation, corrosion control, and structural support. A properly prepared slurry and set cement form a strong, nearly impermeable seal around the casing.

Generally, the cement slurry should have relatively low viscosity to facilitate pumping and maintain effectively constant rheological properties during both preparation at the surface and delivery into the well and the target zone. Assuming the cement slurry is properly prepared and delivered to the target zone, the properties of the set cement will depend primarily on the components of the slurry and the additives included in the slurry composition. Ideally, the properly placed cement will develop high compressive strength in a minimum of time.

In recent years, organic polymeric particles have been employed as additives in the cement slurry to achieve or enhance certain cement properties. Generally, the addition of the polymeric particles leads to improved joining of the slurry constituents, which may help achieve increased strength and high durability characteristics, among other things. The hydrophobic character of the particles may, however, also present some undesirable issues. In particular, mixability and foaming problems may be observed in the polymer-modified cement slurry.

In the field, cement slurries are often prepared using the continuous mixing method, also known as mixing on-the-fly. Solid blends are mixed with water and liquid additives by using a jet mixer. The jet mixer generates a regulated flow of solids that creates a void to draw a dry powder component (due to a venturi effect) into the mix. Unfortunately, the drawing action also draws and entrains air in the slurry. If allowed to stabilize, excess air in the slurry can lead to densely packed air bubbles collecting and then forming at the slurry surface, i.e., foaming. Excessive entrained air and foam can adversely affect the slurry design. For example, it can alter the slurry composition and performance, including deviating from optimal slurry density or increasing slurry viscosity. Such conditions may also cause pumping problems and inefficiencies. Operators attempt to mechanically remove as much of the entrained air from the slurry before pumping, usually through further mixing. However, for slurries containing a large amount of hydrophobic polymer particles, such de-aerating efforts often fall short of removing enough of the entrained air from the slurry to avoid slurry quality issues or pumping problems.

To mitigate foaming problems in cement slurry preparations, different traditional measures are available. Anti-foam and defoamer additives may be added to the slurry to prevent or minimize foaming. Separator equipment may also be used in conjunction with traditional slurry mixers to mechanically remove the entrained air from the slurry. For example, the SlurryAirSeparator device from Schlumberger Ltd. employs a hydrocyclone mechanism to separate and remove entrained air from the cement slurry. As another option, the slurry may be transferred to a large tank for batch mixing. Much of the remaining entrained air may be removed from the slurry. While any of the aforementioned options may be effective in reducing entrained air and foam in the slurry, the employment of these options is not always feasible. For example, operating time and cost associated with using additional equipment or additives may not be acceptable or the equipment may not be readily available in some field locations. Also, some of these measures have proven less than satisfactory in reducing entrained air and foam under certain operating conditions. Thus, there remains a need for methods and\or compositions that reduce, eliminate, or prevent air entrainment and foaming conditions in cement slurries for wellbore completions.

### SUMMARY

The present disclosure is directed to cement slurry compositions having polymeric particles.

Embodiments relate to methods of preventing or controlling foaming in cement slurry preparations or cement operations. Further embodiments relate to methods for cementing or completing a subterranean well comprising a borehole.

In one aspect, a cement slurry composition is provided having cement, water, and organic polymeric additives (such as hydrophobic organic polymer particles like rubber particles). The composition also includes non-ionic surfactants. In various embodiments, the non-ionic surfactant is a non-ionic surfactant containing ethoxylate groups, non-ionic surfactants containing both ethoxylate groups and propyxlate groups, alkoxylates, including alkoxylates containing proplylene oxides, and alkoxylates containing butylene oxide.

In another aspect, a method is described for cementing a subterranean well comprising a borehole. The method entails preparing a cement slurry composition comprised of components including cement, water, polymer particles, and a non-ionic surfactant and pumping the cement slurry composition into the subterranean well and placing the composition in a zone of the subterranean well. Time is then allowed for the cement slurry composition to set into a solid mass in the zone.

In another aspect, a method is described for reducing foam generation in a cement slurry composition having hydrophobic organic polymer particles therein for introduction into a subterranean well. The method includes preparing a dry blend including cement and organic polymer particles, preparing a water solution, and adding a non-ionic surfactant into the water solution. A continuous mixing method is then employed to mix the dry blend in the water solution, whereby the non-ionic surfactant acts to disperse the polymer particles in the solution and to reduce foaming.

### BRIEF DESCRIPTION OF THE DRAWINGS

Further embodiments may be understood with the appended drawings.

FIG. 1 is a graphical illustration displaying contact angle measurements for various aqueous solutions containing different concentrations of non-ionic surfactants;

FIG. 2 is a graphical illustration displaying the relative volume increase over time for various aqueous solutions after mixing; and

FIG. 3 shows photographs of a water solution containing rubber particles.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the cement slurry composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, a “range of from 1 to 10” is to be read as indicating each and every possible number along the continuum between about 1 and about 10. Thus, even if specific data points within the range, or even no data points within the range, are explicitly identified or refer to only a few specific points, it is to be understood that inventors appreciate and understand that any and all data points within the range are to be considered to have been specified, and that inventors possessed knowledge of the entire range and all points within the range.

As described herein, cement slurry compositions (and methods of preparations) are provided in which organic polymeric particles and non-ionic surfactants are included as additives. The cement slurry compositions include a suitable amount of cement and water to make up the base slurry composition, with particular consideration for an optimum balance of mechanical strength in the set cement and ideal viscosity and quality of the slurry. The organic polymeric particles are provided to achieve or enhance a desired property in the slurry or ultimately, in the set cement. The non-ionic surfactants are provided to reduce or eliminate entrained air and foaming which would otherwise be encouraged due to the presence of the largely hydrophobic organic polymeric particles.

As used herein in the context of alleviating entrained air or foam generation issues in the cement slurry, the term “reduce” or “reducing” also means to eliminate, prevent, minimize, or otherwise mitigate the presence or formation of entrained air or foam in the slurry. In accordance with the present disclosure, methods are described that may address the issue by causing entrained air or foam to dissipate or escape from the slurry and/or prevent and discourage formation or accumulation by impacting the conditions that may encourage such formation or accumulation, for example. In respect to foaming, the described methods and compositions may be characterized as incorporating de-foaming or anti-foaming tendencies, or both.

In preferred embodiments, the cement slurry composition generally comprises about 10% to 50% by weight cement or cementious material and about 5% to about 40% by weight organic polymer particles. Further, in these preferred embodiments, the cement slurry composition comprises about 0.05% to about 0.5% by weight non-ionic surfactant. In yet further compositions, particularly those with increasing amounts of additives (including hydrophobic organic polymer particles), the amount of non-ionic surfactant in the cement slurry composition may be as high as about 5% by weight. In other preferred compositions, particularly those with minimum amounts of hydrophobic polymer particles and other additives, the amount of non-ionic surfactant may be as low as about 0.005% by weight.

In a method of cementing a well bore, a cement slurry composition is first prepared at the surface. Preparation of the cement slurry composition preferably entails preparing a dry blend of all the solids including the polymeric particles and a wet blend that includes fresh water and the nonionic surfactant. More additives may be included in the blends as generally known in the art and/or required by the particular cementing operation and wellbore conditions. The dry blend is then added to the wet blend in a standard mixing procedure, using, for example, a jet mixer in a single pass operation and at standard mixing speed and time to sufficiently incorporate all the solids into the mixture. In suitable preparations, the mixing speed was maintained at about 4000 rpm for about 2 minutes. At the end of two minutes, no foaming was observed in the cement slurry.

After mixing, the cement slurry composition may be pumped into the well bore. The cement slurry is typically delivered into the wellbore, filling the annulus between the drilled hole and the casing string. In place, the cement slurry is allowed to cure and harden. Once set, the cement attains the mechanical properties intended of the design, including high strength. The set cement also provides an impermeable seal about the casing.

The slurry compositions described herein may employ any one of the types of cement traditionally used for well completions. These include the more commonly used Portland cement that is produced from limestone and either clay or shale. Most preferably, the cement will meet the chemical and requirements of the American Petroleum Institute and conform with one of the API cement classifications. In any event, it should be understood that the type and formulation of the cement used in an application will depend on several factors, including the conditions expected downhole and the specific purposes or objectives of the cementing operation.

The addition of polymeric particles or fibers to cement slurries has been employed in the prior art to achieve or enhance certain properties in cement slurry or set cement. In general examples, the addition of the polymers enhances the joining of the various slurry constituents and improves the mechanical and durability characteristics of the set cement. The present description deals primarily with organic polymeric particles. For example, in U.S. Patent Applic. Publ. US 2012/0312535, latex particles are described as being used in the design of self healing or self repairing cement systems. These cement systems can adapt to compensate for changes or faults in the physical structure of the cement. In further examples, organic polymer particles have been used as additives in cement slurries to achieve higher flexural strength and toughness, or to improve vibration damping, or to create a seal in the slurry that blocks gas migrations.

Generally, the methods and compositions described herein may employ a variety of hydrophobic particles to achieve a particular purpose or property, and then select a non-ionic surfactant to include in the slurry composition to address potential issues brought on by the selection of hydrophobic particles. In preferred embodiments described herein, organic polymer particles are employed, which have been observed to be largely hydrophobic. In selecting a surfactant to join the hydrophobic particles in the slurry mix, consideration include whether the surfactant will be stable in the slurry and whether it might negatively impact the performance of the organic polymer particles and/or the cement slurry composition. In addition to the use of rubber particles described herein, methods and compositions according to the present disclosure may employ some of following organic particles: poly(acrylic); poly(acrylonitrile); poly(acrylamide); maleic anhydride polymers; Polyamides; Polyimides; polycarbonates; Polymers made from diene monomers; saturated and unsaturated polymers containing ester functionality in the main polymer chain, such as poly(ethylene terephthalate) (PET); polyurethanes′Poly(propylene glycol); Fluorocarbon polymers; Polyethylene, polypropylene, their copolymers; Polystyrene; Poly(vinyl acetal); Poly(Vinyl) polymers; Poly(Vinylidene) Chlorides; Poly(vinyl acetate); Poly(Vinyl Ether) and poly(Ketone); Gilsonite; Graphite; Coals; and Wax. In certain preferred compositions, the amount of hydrophobic organic polymer particles is roughly 25% by weight of solid blend, which is relatively high, and in further embodiments, may be about 35% by weight of solid blend.

As discussed above, the presence of a large amount of organic polymer particles in the cement slurry can lead to foaming issues. The hydrophobic nature of the organic polymer particles tends to stabilize the interfaces between air and the surfaces of the polymer particles, which, in time, causes a transformation of the entrained air and air bubbles into stable foam. In the field, it becomes imperative to alleviate this foam condition prior to introduction of the cement slurry into the well. In accordance with the present description, non-ionic surfactants are also added to the cement slurry to help reduce the amount of entrained air in the polymer-modified slurry and alleviate foaming conditions.

Surfactants are organic compounds that contain both hydrophobic groups (the tails) and hydrophilic groups (the heads). Surfactants diffuse in water and adsorb at interfaces between air and water or oil and water. The insoluble hydrophobic tail may extend out of the bulk water phase, e.g., into the oil phase, while the water soluble head remains in the water phase. The alignment of the surfactants at the surface modifies the surface properties of water at the water\oil or water\oil interface. The class of surfactants selected and employed in the presently described compositions is a non-ionic surfactant, which is characterized by a hydrophobic group or head that does not contain a net charge. In the bulk aqueous phase, surfactants form aggregates characterized by a hydrophobic group or tail that form the core and hydrophilic heads that typically surround the core and contact the surrounding liquid. The hydrophilic-lipophilic balance or HLB value of the surfactant is a measure of the degree to which the surfactant is hydrophilic or liphophilic, as determined by the relative sizes of the hydrophilic groups and hydrophobic groups.

Generally, selected non-ionic surfactants are soluble in water and exhibit chemical stability in the cement slurry composition (i.e., very high pH and strong ionic strength). Use of the selected surfactant in the cement slurry composition will also promote wettability of hydrophobic particles and a low foam generation or good defoaming effect, combined with dispersion of the hydrophobic particles in the solution. Preferably, as shown further below, the non-ionic surfactant selected contains both ethoxylate and propoxylate groups in the hydrophilic part. Other suitable non-ionic surfactants include fatty alcohol alkoxylates that contain moles of propylene oxide or butylene oxide. This class non-ionic surfactants offer increased wettability results with a defoaming effect, when the temperature of application is above their cloud point.

Applicants have established that when such non-surfactants are used as cement slurry additives in conjunction with hydrophobic organic polymer particles, the presence of foam in the cement slurry after mixing is substantially reduced. In accordance with the present disclosure, selected nonionic surfactants are added to the cement slurry composition and, when mixed, increase the surface tension between water and air (or other types of gases), thereby, de-stabilizing foam (de-foamer) or preventing the formation of foam (anti-foam). The surfactant tendency to de-foam will depend on several parameters: surfactant chemistry and structure; ratio between hydrophobic and hydrophilic part (generally, higher hydrophobicity means lesser foaming tendency); surfactant quantity; and the rate of absorption on a surface.

Moreover, without the addition of the non-ionic surfactants, air bubbles would stabilized by the hydrophobic particle surface and accumulate between the particles. This would lead to a stable aggregation of particles and air bubbles, which, among other things, alter cement slurry density specifications and prevent proper mixing of the organic polymer particles. The selected non-surfactants act as a wetting agent that effectively reduces the surface tension between the hydrophobic particles and water. This subsequently reduces the amount of air trapped at the particle surface and promotes the dispersion of the hydrophobic particles in water. This dispersion improves the mixability of the cement slurry containing the polymeric particles, and also reduces the slurry's tendency to retain entrained air. As a result, the presence of foam in the slurry during preparation is reduced and the cement slurry may be pumped into the well without further deaerating techniques.

The concentration of surfactant added in the cement slurry composition is dependent on the slurry formulation. More particularly, the preferred surfactant concentration will be largely dependent on the amount of hydrophobic particles added to the composition and the surface area presented by the particles. Greater amounts and larger surface areas will warrant higher concentrations of surfactant to address mixability issues. It is noted that a given concentration of smaller particles in a cement slurry will present a greater total surface area than the same concentration made up of larger particles in the same cement slurry, and thus, require a higher concentration of surfactant. In one sense, methods and compositions according to the present disclosure allow for the use of not only greater concentrations of hydrophobic organic polymers in the slurry, but a greater number of polymers, which may be independently advantageous. In certain preferred compositions, the amount of hydrophobic particles is roughly 25% by weight of solid blend, which is relatively high, but in some cases, this number can reach 35%.

Thus, in one aspect, the present disclosure provides methods of cementing and cement slurry preparation that allow higher concentrations of hydrophobic particles to be added to the slurry without encountering mixability and foaming issues. The inclusion of increased concentrations of hydrophobic particles will impart desirable or enhanced properties on the cement slurry or set cement that would not have been previously attainable. For example, with increased concentrations of certain polymeric particles, the cement slurry would swell more and achieve relatively greater volume, and be lighter, more flexible, elastic, lighter—all desirable properties. These improved properties would not be achieved, however, if slurry mixability were an issue.

It is well known to those skilled in the relevant art that a variety of other components and additives may be included in the cement slurry compositions. These include fluid loss additives, set retarding agents, dispersing agents, lightweight extenders, and the like. Slurry compositions described or experimented in this disclosure reveal some of these additives (see e.g., Tables 1, 2 and 3 below). The inclusion of these additives and their effect on the non-ionic surfactant, the hydrophobic particles, and the cement slurry, in general, may be a relevant consideration in the selection of the types and amounts of non-ionic surfactants for the cement slurry composition.

To commence a preferred method of cementing or well completion, according to the present teachings, a solids or dry blend of cement and additives is prepared. The cement may be one of the various types in accordance with the API classes and suitable for the cementing application and with the various additives intended. In this embodiment, the additives include organic polymer particles, such as rubber particles, that have been selected to increase the flexural strength and ductility in the set cement. An aqueous solution is also prepared beginning with fresh water at an amount required for a suitable slurry composition and including one or more additives. In one embodiment, the additive mixed into the water is a non-ionic surfactant such as an octylpehenol ethoxylate (Triton X-45 or Triton X-102 from Dow Chemical Co. in Houston, Tex.) or an ethoxylate\propoxylate (Tregitol minfoam 2X from Dow Chemical Co.). The dry blend, containing all the solid additives is added to the water solution using a jet mixer, for example, to make the desired cement slurry. For more precision control, the blends may be batch mixed by circulating in a large tank and using a batch mixer.

As with most cement slurry preparations, the goal of the mixing process is to obtain a consistent slurry with the proper amount of additives and water, and at the target density. The optimum cement-water ratio is generally a balance between achieving maximum strength at complete hydration and having sufficient water volume to lower the viscosity of the slurry to pumpable levels. The viscosity must be reduced to facilitate pumping the cement slurry through the long narrow annulus of the wellbore.

Table 1 presents the components of a cement slurry composition in accordance with one embodiment. The slurry contains a cement additive to prevent annular migration of gas into the cement slurry during critical hydration period. The cement additive is a suspension of polymer microgels, which form an impermeable filter cake that blocks gas migration. In this preferred composition, the non-ionic surfactant is an alkoxylate surfactant.

TABLE 1
Cement Slurry Composition

| | | | | | |
|---|---|---|---|---|---|
| Job Type | Casing | Depth | 6000 feet | TVD | 6000 feet |
| BHST | 150 deg F. | BHCT | 115 deg F. | BHP | 3500 psi |
| Starting Temp. | 80 deg F. | Time to Temp. | 00:33 | Heating | 1.05 deg F./min |
| | | | hr:mm | Rate | |
| Starting | 450 psi | Time to | 00:33 | Schedule | 9.5-3 |
| Pressure | | Pressure | hr:mm | | |

Composition

| | | | | | |
|---|---|---|---|---|---|
| Slurry Density | 15.74 lb/gal | Yield | 1.12 ft3/sk | Mix Fluid | 3.76 gal/sk |
| Solid Vol. | 55.0% | Porosity | 45.0% | Slurry type | FUTUR-G |
| Fraction | | | | | |

| Code | Concentration | Sack Reference | Component | Blend Density |
|---|---|---|---|---|
| Cement Blend | | 100 lb of BLEND | Blend | 2.61 g/cm3 |
| Fresh Water | 2.92 gal/sk | | Base Fluid | |
| Gas migration | 0.589 gal/sk | | Additive | |
| control additive | | | | |
| Anti-foam agent | 0.050 gal/sk | | Antifoam | |
| Liquid dispersant | 0.100 gal/sk | | Dispersant | |
| Non-ionic | 0.100 gal/sk | | | |
| surfactant | | | | |

### EXAMPLES

It should be recognized that the examples below are provided to aid in a general understanding of the present teachings. The examples should not be construed so as to limit the scope and application of such teaching to the content of the examples. It is noted that rubber particles were selected as the organic polymer particles in some of the examples and the experiments partly because rubber particles are frequently used as an additive in cement slurries for well completions and those skilled in the relevant art are likely to be familiar with the usage. In any case, the selection of rubber particles is provided to facilitate description only, and, the present description's focus on such use should not be deemed limiting of the proposed concepts and teachings. The proposed compositions and methods are also applicable to cement slurry compositions employing other hydrophobic polymer particles to achieve or enhance certain properties in the slurry or set cement.

The experiments were generally set out to show the effect of different surfactants on the wettability of rubber particles in water solutions. For these experiments, several non-ionic surfactants were selected for inclusion in a cement slurry composition. Each of the selected surfactants is a product made commercially available by the Dow Chemical Company in Houston, Tex. The nonionic surfactants include the following: Triton-X45, Triton X-102 and Tergitol MinFoam 2X. The characteristics of these products are reported in Table 1. The first two surfactants are octylphenol ethoxylate molecules which differ by the size of the hydrophilic head: Triton x-45 contains 4.5 moles of ethyleneoxide (EO) while 12 EO moles are present in Triton X-102. As a result, the two surfactants have a different hydrophilic-liphophilic balance: the HLB value is ˜10 for Triton X-45 while it is ˜14 for Triton X-102. The third surfactant has a different chemistry and contains both ethoxylate and propoxylate groups in the hydrophilic part. As reported in the Table 2, the non-ionic surfactant Tergitol MinFoam 2x presents an intermediate HLB value (˜12) and a much lower CMC (24 μM).

TABLE 2
Properties of Three Non-Ionic Surfactants Investigated

| | Surfactant | | |
|---|---|---|---|
| | Triton | Triton | Tergitol |
| | X-45 | X-102 | MinFoam |
| Chemistry | Octylphenol | Octylphenol | Ethoxylate |
| | Ethoxylate | Ethoxylate | Propoxylate |
| | EO moles: | EO moles: | |
| | 4.5 | 12 | |
| HLB | 10 | 14 | 12 |
| CMC (μM) | 136 | 267 | 24 |
| Surface Tension | 29 | 36 | 21 |
| (dynes/cm) | | | |
| 1% in water | | | |
| at 25 deg C. | | | |

### Example 1

The aim of a first experiment was to evaluate the effect of the selected surfactants on wettability, i.e., on the wettability of a surface of a polymer particle. For each selected surfactant, several water solutions each containing different amounts of the surfactant were provided, including a first control solution that contained 0% surfactant concentration. The contact angle for each solution was measured using a Tracker tensiometer from Teclis. Because the measurement of contact angles on powders presents some experimental difficulties, contact angle measurements were carried out on rubber bands.

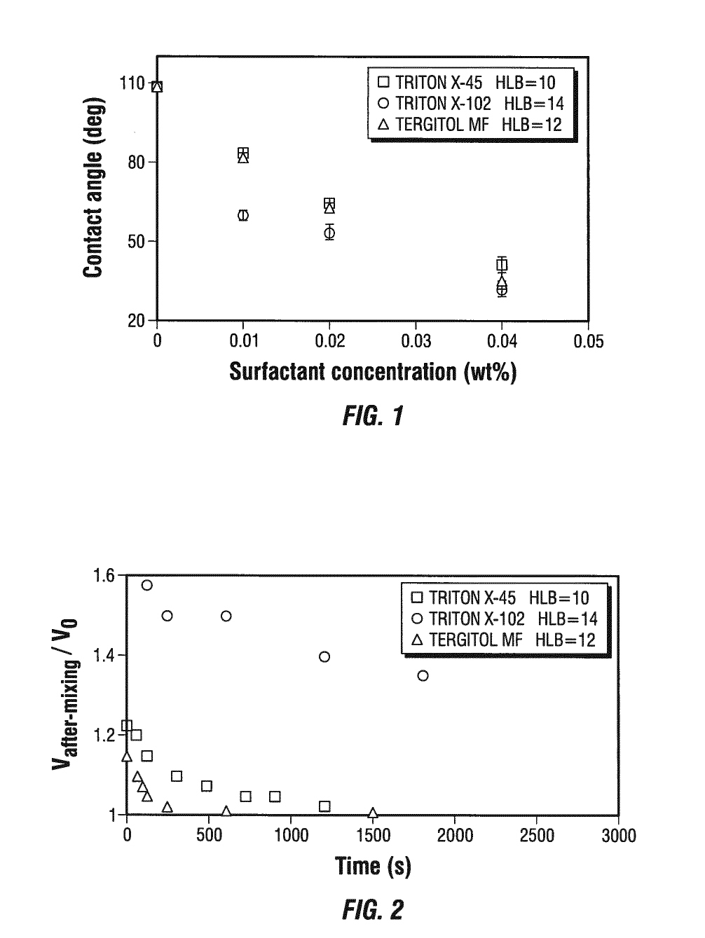

The results obtained are provided in the graph of FIG. 1, where the average measured contact angle is plotted as a function of the surfactant weight concentration in water for the different solutions tested. As shown, the value of the contact angle for a water solution without surfactant is 110 degrees. This measurement for the first solution confirms the poor wettability of the polymer surface. For the water solutions containing a concentration of one of the surfactants, wettability in respect to the rubber surface is considerably improved. As illustrated by FIG. 1, the contact angle decreases as the amount of surfactant in the solution is increased from 0.01% to 0.04% by weight. At 0.04% concentration, the contact angle for each solution is reduced to the neighborhood of about 25 degrees.

The results of this experiment show that the addition of the non-ionic surfactants to the water solutions improves the wettability of the water solution in respect to a rubber surface. The experimental results suggest, therefore, that the inclusion of the non-ionic surfactants to a cement slurry composition that incorporate rubber particles will improve the wettablity of the water solution-rubber particle interfaces.

### Example 2

To evaluate the degree to which air is entrained by the selected surfactants during mixing, a series of foaming tests were conducted. A Warring blender was used to mix 200 mL of water solutions containing two different concentrations of surfactants, 0.04% and 0.1%. To reproduce the same mixing speeds used in standard API procedures for cement slurries, the solutions were first mixed at 4000 revolutions per minutes (rpm) for 35 seconds and subsequently at 12000 rpm for the same period of time. After mixing, the volume of each of the solutions was measured as a function of time to determine the quantity of air bubbles generated during mixing and retained in the solution.

On the graph of FIG. 2, the ratio between the volume measured after mixing, V_{after-mixing}, and the initial volume, V₀, is plotted as a function of time for solutions containing 0.04% of surfactants. For each of the three surfactants tested, the ratio V_{after-mixing}/V₀ is highest right after mixing, at t=0, and then generally decreases with time. This suggests that air bubbles are present in the solutions after mixing and that an initial foam is generated, which results in an increase in the volume of the solution. The graphs indicate further that the ratio V_{after-mixing} generally stabilizes after an initial time period, meaning that air bubbles collapse and the foam dissipates.

FIG. 2 suggests that, for the surfactant Tergitol MinFoam, the amount of air entrained in the solution is less of a problem as the initial volume, V₀, is relatively low and more importantly, the solution returns to initial volume after only a few minutes. That is the air bubbles in the solution collapses soon after mixing and the foam generated at mixing dissipates relatively quickly. In contrast, the solution with Triton X-102 appears to generate quite a bit more air bubbles during mixing and tends to maintain the bubbles more so than the other solution. In fact, this solution maintains a volume increase of more than 40% even after 20 minutes.

Water solutions were then provided with higher concentrations (0.1%) of the same surfactants and mixed as before. At t=0, the amount of foam observed in each of the water solution having the Triton surfactants was higher than as observed at the lower concentration (0.04%). For the solution containing Tergitol MinFoam at the higher concentration, the amount of foam observed was comparable to the amount observed in the solution containing the lower concentration of the non-ionic surfactant. For each of the solutions having the higher concentration of surfactant, the rate at which the volume of solution decreased with time corresponded well with what was observed at the lower concentration. In other words, more foam is generated initially, but the foam dissipates in the same manner as observed for solutions with the lower concentration of surfactant.

### Example 3

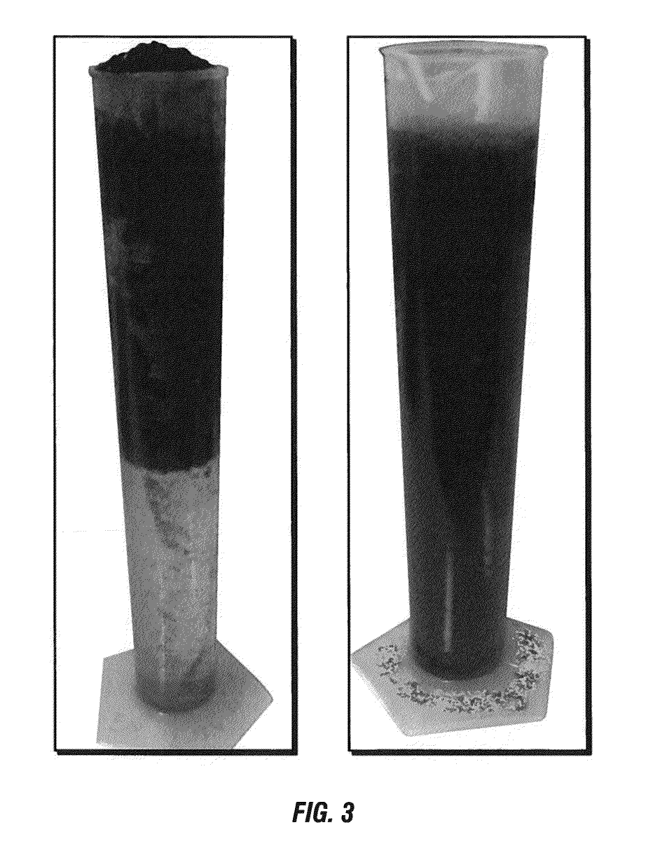

The purpose of a further experiment was to determine the effect of the addition of the surfactant on the dispersion of rubber particles in water, and on the mixability of a cement slurry. FIG. 3 provides two depictions of a column of a water solution incorporating additives in the form of hydrophobic rubber particles. The first depiction A, on the left, shows the water solution exhibiting two clearly distinguishable phases: a rubber particle phase and a water phase. In the second depiction B, to the left of the first, the hydrophobic rubber particles have been mixed directly in a water solution containing 0.04% of Tergitol MinFoam. In clear contrast to the first solution without the surfactants, a single phase is observed indicating good, homogeneous dispersion of the polymeric particles in the water solution. This dispersion remained stable for more than 48 hours.

This example establishes, therefore, that the addition of the selected non-ionic surfactants renders the hydrophobic rubber particles to readily disperse in the water solution. This suggests, as well, that the addition the non-ionic surfactants in cement slurry incorporating hydrophobic polymer particles will encourage dispersion of the polymer particles in the solution and good mixability of the cement slurry composition.

### Example 4

In order to determine the effect of the presence of the surfactant on the mixability of a cement slurry, a slurry design containing rubber particles was studied. In a preliminary base test, the slurry was mixed following the laboratory procedure. The dry blend, containing all the solid additives including an antifoam additive, was added to the liquid phase while mixing at 4000 rpm and the time required to fully incorporate the solids was measured. More than 5 minutes were required in this case.

The, a nonionic surfactant, Tergitol MinFoam, was added to the water solution at a concentration of about 0.1% by weight. Also, the antifoam additive was removed from the formulation, to isolate possible entrainment of air caused by the surfactant. After the new design was mixed following the same procedure, the mixed solution was observed to be without foam. The time required to incorporate the solid was about 2 minutes in this case, which is considerably a shorter period that what was required in the first case. This establishes that the addition of the non-ionic surfactant improves the mixability of the cement slurry and as compared to use of the antifoam additive, is more effective in penetrating foam generation.

TABLE 3
Slurry Design Comprising Rubber Particles

| | | |
|---|---|---|
| Code | Concentration | Mass (g/600 mL) |

DRY PHASE (total = 657.8 g) SVF = 55.0%
Blend Total = 657.8 g

| | | | |
|---|---|---|---|
| G cement | 34.7% | BVOB | 366.54 |
| Rubber | 24.0% | BVOB | 95.04 |
| Additive 1 | 26.3% | BVOB | 65.07 |
| Additive 2 | 15.0% | BVOB | 131.18 |

WET PHASE (total = 269.3 g)

| | | | |
|---|---|---|---|
| Antifoam | 4.44 | L/tonne VBWOC | 1.63 |
| Cement dispersant | 1.00 | L/tonne VBWOC | 0.45 |
| FRESH_WATER | 407.40 | L/tonne of Blend | 267.2 |

BVOB: By Volume Of Blend
VBWOC: Volume by weight of Cement

Although various embodiments have been described within respect to enabling disclosures, it is to be understood the disclosed embodiments are not limiting. Variations and modifications that would occur to one of skill in the art upon reading the specification are also within the scope of the disclosure, which is defined in the appended claims.

What is claimed is:

1. A cement slurry composition comprising:
cement;
water;
organic polymer additives; and
a non-ionic surfactant.

2. The cement slurry composition of claim 1, wherein the organic polymer additives are organic polymer particles and wherein the non-ionic surfactant has a hydrophilic group that contains ethoxylate groups and propoxylate groups.

3. The cement slurry composition of claim 1, wherein the organic polymer additives are organic polymer particles and wherein the non-ionic surfactant is an octylphenol ethoxylate.

4. The cement slurry composition of claim 3, wherein the non-ionic surfactant contain between about 4.5 moles to 12 moles of ethyleneoxide.

5. The cement slurry composition of claim 3, wherein the hlb value of the non-ionic surfactant is between about 10 and about 14.

6. The cement slurry composition of claim 1, wherein the organic polymer additives are rubber particles and the non-ionic surfactant contains ethoxylate groups and has an hlb value between about 10 and 14.

7. The cement slurry composition of claim 1, wherein the non-ionic surfactant is selected from the group of non-ionic surfactants consisting of: non-ionic surfactant containing ethoxylate groups; non-ionic surfactants containing both ethoxylate groups and propyxlate groups; alkoxylates containing propylene oxides; and alkoylates containing butylene oxide.

8. The cement slurry composition of claim 1, wherein the organic polymer additives are rubber particles.

9. The cement slurry composition of claim 1, further comprising:
an anti-foam agent; and
a dispersant.

10. The cement slurry composition of claim 1, wherein the organic polymer additives are present at a concentration of between about 5% to about 40% by weight and the non-ionic surfactant is present at a concentration of between about 0.005% to about 5% by weight.

11. The cement slurry composition of claim 10, wherein the non-ionic surfactant is present at a concentration of between about 0.05% to about 0.5% weight and the cement is present at a concentration of between about 10% to about 50% by weight.

12. A method of cementing a subterranean well comprising a borehole, comprising:
preparing a cement slurry composition comprised of components including cement, water, polymer particles, and a non-ionic surfactant;
pumping the cement slurry composition into the subterranean well and placing the composition in a zone of the subterranean well; and
allowing time for the cement slurry composition to set into a solid mass in the zone.

13. The method of claim 12, wherein the non-ionic surfactant includes non-ionic surfactants containing ethoxylate groups and propyxlate groups in the hydrophilic group.

14. The method of claim 12, wherein preparing the cement slurry composition includes,
preparing a dry blend containing the cement and organic polymer particles,
preparing a wet blend containing the water and the non-ionic surfactant, and
mixing the dry blend and wet blend at a cement to water ratio suitable to make a base slurry.

15. The method of claim 14, wherein preparing the cement slurry composition includes employing a jet mixer to mix the dry blend and the liquid blend in continuous mixing mode.

16. The method of claim 12, wherein the polymer particles are rubber particles and the non-ionic surfactant contains ethoxylate groups.

17. The method of claim 12, further comprising, prior to preparing the cement slurry composition, providing a non-ionic surfactant selected from the group of non-ionic surfactants consisting of: non-ionic surfactant containing ethoxylate groups; non-ionic surfactants containing both ethoxylate groups and propyxlate groups; and combinations thereof.

18. The method of claim 12, wherein preparing the slurry composition includes providing amounts of the cement, polymer particles, and non-ionic surfactant to produce a cement slurry composition having between about 5% to about 40% by weight of the polymer particles and between about 0.05% to about 0.5% by weight of the non-ionic surfactant.

19. A method of reducing foam generation in a cement slurry composition having hydrophobic organic polymer particles therein for introduction into a subterranean well, the method comprising:
preparing a dry blend including cement and organic polymer particles;
preparing a water solution;
adding a non-ionic surfactant into the water solution; and
using a continuous mixing method to mix the dry blend into the water solution, whereby the non-ionic surfactant acts to disperse the polymer particles in the solution and to reduce foaming.

20. The method of claim 19, wherein the polymer particles are rubber particles and the non-ionic surfactant contains both ethoxylate groups and propyxylate groups in the hydrophilic part, the non-ionic surfactant being added to constitute between about 0.05% to about 0.5% by weight non-surfactant in the cement slurry composition.
